(19) United States
(12) Patent Application Publication
(10) Pub. No.: US 2007/0128504 A1
(43) Pub. Date: Jun. 7, 2007

(54) Solid oxide fuel cell and method for the production thereof

(75) Inventors: Michio Horiuchi, Nagano (JP); Yasue Tokutake, Nagano (JP); Shigeaki Suganuma, Nagano (JP); Jun Yoshiike, Nagano (JP); Fumimasa Katagiri, Nagano (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD.

(21) Appl. No.: 11/604,754

(22) Filed: Nov. 28, 2006

(30) Foreign Application Priority Data
Nov. 29, 2005 (JP) P. 2005-344160

(51) Int. Cl. H01M 4/86; H01M 8/12; C04B 35/64

(52) U.S. Cl. 429/44; 429/30; 264/618

(57) ABSTRACT

The solid oxide fuel cell includes a solid electrolyte substrate 11 formed by a fired electrolyte powder, a cathode electrode layer 12 formed on one side of the electrolyte substrate and an anode electrode layer 13 formed on the other side of the electrolyte substrate. Metallic meshes M1, M2 are provided on the cathode electrode layer side and the anode electrode layer side of the electrolyte substrate, respectively. A metallic mesh is plane-pressed onto the both sides of an electrolyte sheet having a predetermined shape prepared from an electrolyte green sheet. A cathode electrode paste layer is formed on one side of the electrolyte sheet while an anode electrode paste layer is formed on the other side of the electrolyte sheet. The electrolyte sheet, the cathode electrode paste layer and the anode electrode paste layer are then integrally fired. When the firing is terminated, a solid oxide fuel cell is completed.

### BACKGROUND OF THE INVENTION

The present invention relates to a solid oxide fuel cell and a method for the production thereof and more particularly to a solid oxide fuel cell-which can be produced by a method which includes preparing a solid electrolyte substrate constituting the fuel cell having a simple structure obtained from a fired solid electrolyte powder rather than a dense structure obtained by sintering a solid electrolyte material to attain cost reduction as well as enhancement of thermal shock resistance.

The volume density of the electrolyte becomes equal to or less than 70% by firing and becomes equal to or more than 90% by sintering.

In recent years, fuel cells of various types of electricity generation have been developed. Among these types of fuel cells is a solid oxide fuel cell of the type including a solid electrolyte. An example of the fuel cell including a solid electrolyte is one including as an oxygen-ionically conductive solid electrolyte substrate a sintered material made of stabilized zirconia having yttria (Y₂O₃) incorporated therein. A cathode electrode layer is formed on one side of the solid electrolyte substrate while an anode electrode layer is formed on the other side of the solid electrolyte substrate. Oxygen or an oxygen-containing gas is supplied into the fuel cell on the cathode electrode layer side thereof while a fuel gas such as methane is supplied into the fuel cell on the anode electrode layer side thereof.

In this fuel cell, oxygen (O₂) which has been supplied into the cathode electrode layer is ionized to oxygen ion (O₂₋)

at the interface of the cathode electrode layer with the solid electrolyte substrate. The oxygen ion is conducted through the solid electrolyte substrate to the anode electrode layer. In the anode electrode layer, the oxygen ion then reacts with the gas such as methane (CH₄) which has been supplied thereinto to produce water (H₂O), carbon dioxide (CO₂), hydrogen (H₂) and carbon monoxide (CO). In this reaction, oxygen ion releases electron to make some difference in potential between the cathode electrode layer and the anode electrode layer. Accordingly, a lead wire can be attached to the cathode electrode layer and the anode electrode layer so that electron in the anode electrode layer flows through the lead wire toward the cathode electrode layer to generate electricity as a fuel cell. The driving temperature of the fuel cell is about 1,000° C.

However, this type of a fuel cell requires that separate chambers be provided, that is, an oxygen or oxygen-containing gas supplying chamber be provided at the cathode electrode layer side thereof and a fuel gas supplying chamber be provided at the anode electrode layer side thereof. Further, since this type of a fuel cell is exposed to an oxidizing atmosphere and a reducing atmosphere at high temperatures, it is difficult to enhance the durability as fuel cell unit.

On the other hand, a fuel cell has been developed which includes a cathode electrode layer and an anode electrode layer provided on the opposing sides of two sheets of solid electrolyte substrate, respectively, to form a fuel cell unit that is adapted to be disposed in a fuel gas such as mixture of methane gas and oxygen gas to cause the generation of electromotive force between the cathode electrode layer and the anode electrode layer. The principle of this type of a fuel cell in the generation of electromotive force between the cathode electrode layer and the anode electrode layer is the same as that of the aforementioned separate chamber type fuel cell. However, since the aforementioned proposal is advantageous in that the fuel cell unit can be entirely disposed in substantially the same atmosphere, it can be in the form of a single chamber which can be supplied with a mixed fuel gas, making it possible to enhance the durability of the fuel cell unit.

However, this single chamber type fuel cell, too, must be driven at a temperature as high as about 1,000° C. and thus is subject to the risk of explosion of mixed fuel gas. When the oxygen concentration is lowered under the flammability limit to avoid this risk, the carbonation of the fuel such as methane proceeds, raising a problem of deterioration of cell performance. In order to solve this problem, a single chamber type fuel cell has been proposed which can employ a mixed fuel gas in an oxygen concentration allowing prevention of explosion of mixed fuel gas as well as prevention of progress of carbonation of fuel (see, e.g., Patent Reference 1).

The configuration of the above proposed single chamber type fuel cell is shown in FIG. 10. The fuel cell shown in FIG. 10A includes a plurality of solid oxide fuel cells each containing a solid electrolyte layer laminated on each other parallel to the flow of a mixed fuel gas. The solid oxide fuel cell includes a solid electrolyte substrate 1 having a dense structure and a porous cathode electrode layer 2 and a porous anode electrode layer 3 formed on the respective side of the solid electrolyte substrate 1. A plurality of fuel cells CO1 to CO4 having the same configuration are laminated on each other in a vessel 4 made of ceramics. These fuel cells are hermetically sealed in the vessel 4 by end plates 9, 10 with fillers 7, 8 provided interposed therebetween.

The vessel 4 is provided with a feed pipe 5 for mixed fuel gas containing a fuel such as methane and oxygen and a discharge pipe 6 for exhaust gas. The vessel 4 is filled with fillers 7, 8 in the space excluding the fuel cell unit and allowing the flow of the mixed fuel gas and the discharge gas in such an arrangement that a proper gap is formed. In this arrangement, when this system is driven as a fuel cell, ignition cannot occur even when a mixed fuel gas within the flammability range exists.

The basic configuration of a fuel cell shown in FIG. 10B is the same as that of the single chamber type fuel cell shown in FIG. 10A. However, this fuel cell includes a plurality of solid oxide fuel cells each containing a solid electrolyte layer laminated along the axis of the vessel 4 perpendicular to the flow of the mixed fuel gas. In this case, the solid oxide fuel cell includes a porous solid electrolyte substrate 1 and a porous cathode electrode layer 2 and an anode electrode layer 3 formed on the respective side of the solid electrolyte substrate 1. A plurality of fuel cell units CO1 to CO5 having the same configuration are laminated in the vessel 4.

The aforementioned fuel cell includes fuel cell units received in a chamber. On the other hand, a solid oxide fuel cell device has been proposed which is adapted to be disposed in or in the vicinity of flame so that the heat of flame causes the solid oxide fuel cell to be kept at its operating temperature to generate electricity. An embodiment of this solid oxide fuel cell is a solid oxide fuel cell including an anode electrode layer formed on the outer surface of a tubular solid electrolyte substrate.

This type of a solid oxide fuel cell is mainly disadvantageous in that radical components from flame cannot be supplied into the upper half of the anode electrode layer, disabling the effective use of the entire surface of the anode electrode layer formed on the outer surface of the tubular solid electrolyte substrate. Thus, this type of a solid oxide fuel cell exhibits a low electricity generation efficiency. Further, since this type of a solid oxide fuel cell is unevenly heated directly by flame, it is disadvantageous in that sudden temperature change can easily cause cracking.

In order to solve these problems, an electricity generating device including a solid oxide fuel cell has been proposed as a simple electricity supplying unit which employs a solid oxide fuel cell of the type allows direct utilization of flame produced by the combustion of a fuel in such a manner that the entire surface of an anode electrode layer formed on a flat solid oxide substrate is exposed to flame, thereby enhancing the durability and electricity generation efficiency and reducing the size and cost (see, e.g., Patent Reference 2).

An electricity generation device including the above proposed solid oxide fuel cell is shown in FIG. 11. A solid oxide fuel cell C0 utilized in the electricity generation device shown in FIG. 11 includes a flat circular and rectangular solid electrolyte substrate 1, a cathode electrode layer 2 formed as an air electrode (oxygen electrode) formed on one side of the substrate 1 and an anode electrode layer 3 formed as a fuel electrode on the other side of the substrate 1. The cathode electrode layer 2 and the anode electrode layer 3 are disposed opposed to each other with the solid electrolyte substrate 1 provided interposed therebetween.

The solid oxide fuel cell C0 thus configured is used as an electricity generation device which is adapted to be exposed to flame f produced by the combustion of a fuel gas while being supported over a gas burner 4 into which a fuel gas is supplied with the anode electrode layer 3 of the fuel cell C0 facing downward. A fuel which is combusted to produce flame causing oxidation is supplied into the gas burner 4. As the fuel there may be used phosphorus, sulfur, fluorine, chlorine or a compound thereof. An organic material which requires no discharge gas treatment is preferred. Examples of the organic fuel employable herein include gases such as methane, ethane, propane and butane, gasoline-based liquids such as hexane, heptane and octane, alcohols such as methanol, ethanol and propanol, ketones such as acetone, other organic solvents, food oils, kerosine, paper, andwood. Particularly preferred among these organic materials are gases.

Flame may be diffusion flame or premixed flame. However, since diffusion flame is unstable and generates soot that can easily deteriorate the performance of the anode electrode layer, premixed flame is preferred. Premixed flame is stable and can be easily adjusted in its size. Further, premixed flame can be properly adjusted in fuel concentration to prevent the generation of soot.

Since the solid oxide fuel cell C0 is in a flat form, flame f from the burner 4 can be uniformly applied to the anode electrode layer 3 of the solid oxide fuel cell C0, making it possible to apply flame f to the anode electrode layer 3 without unevenness as compare with the tubular fuel cell. Further, by disposing the anode electrode layer 3 facing flame f, hydrocarbons, hydrogen, radicals (OH, CH, C₂, O₂H, CH₃) existing in the flame can be easily used as fuel for electricity generation based on oxidation-reduction reaction. Moreover, since the cathode electrode layer 2 is exposed to a gas containing oxygen such as air, oxygen can be easily used on the cathode electrode layer 2. Further, by blowing a gas containing oxygen onto the cathode electrode layer 2, the solid oxide fuel cell can be more efficiently rendered more oxygen-rich on the cathode electrode layer side thereof.

The electric power generated in the solid oxide fuel cell Co is drawn out through lead wires L1, L2 extending from the cathode electrode layer 2 and the anode electrode layer 3, respectively. As each of the lead wires L1, L2 there is used one made of heat-resistant platinum or platinum alloy.

[Patent Reference 1] JP-A-2003-92124

[Patent Reference 2] JP-A-2004-139936

The solid oxide fuel cells mentioned above each include a cathode electrode layer and an anode electrode layer formed on a sheet of flat solid electrolyte substrate. Such a solid oxide fuel cell is produced in the same manner. Firstly, a circular or rectangular sheet having a predetermined size allowing shrinkage which would be caused by sintering is formed by a green sheet made of a solid electrolyte material. The green sheet having a predetermined size is then sintered to prepare an electrolyte substrate for solid oxide fuel cell.

Subsequently, a cathode electrode paste layer is formed on one side of the electrolyte substrate 1 by printing while an anode electrode paste layer is formed on the other side of the electrolyte substrate 1 by printing. Thereafter, a metallic mesh is added to one or both of the cathode electrode paste layer and the anode electrode paste layer thus formed. Further, the cathode electrode paste layer and the anode electrode paste layer are fired. Thus, a sheet of solid oxide fuel cell having a predetermined size is completed.

The metallic mesh added to the cathode electrode paste layer and the anode electrode paste layer has an effect of retaining small pieces of fuel cell which would be produced even if the substrate is cracked by thermal shock applied to the solid oxide fuel cell during electricity generation. The fuel cell thus cracked remains capable of generating electricity. The metallic mesh acts to electrically connect small pieces of fuel cell. In this arrangement, electric power can be drawn out through lead wires L1 and L2. The metallic mesh also prevents the separation of fuel cell pieces produced by cracking to maintain the form of a sheet of solid oxide fuel cell.

In accordance with the aforementioned procedure of producing a solid oxide fuel cell, a green sheet made of an electrolyte material is sintered at high temperature to form a ceramic material having a dense solid. During the sintering of the green sheet, cracking due to the shrinkage of the volume of the green sheet occurs, occasionally making it impossible for the electrolyte substrate to be used for fuel cell. The effect of shrinkage can cause the sintered substrate to be defected even if no cracking occurs. Accordingly, the electrolyte substrate is produced in a poor yield. In order to raise the yield, the preparation of the green sheet and the sintering of the green sheet require much trouble, adding to the product cost.

### SUMMARY OF THE INVENTION

It is therefore an aim of the invention to provide a solid oxide fuel cell which can be produced by a method which includes preparing a solid electrolyte substrate constituting the fuel cell having a simple structure obtained from a fired solid electrolyte powder rather than a dense solid obtained by sintering a solid electrolyte material to attain cost reduction as well as enhancement of thermal shock resistance and a method for the production thereof.

In order to solve the aforementioned problems, there is provided a solid oxide fuel cell including: a solid electrolyte substrate formed by a fired electrolyte powder; a cathode electrode layer formed on one side of the solid electrolyte substrate; and an anode electrode layer formed on the other side of the solid electrolyte substrate, wherein an electrically-conductive material layer made of a plurality of conductors is provided on one or both of the cathode electrode layer side and the anode electrode layer side.

Further, the plurality of conductors form a metallic mesh.

Further, the electrically-conductive material layer is embedded in the cathode electrode layer and/or in the anode electrode layer.

Further, the electrically-conductive material layer is embedded in over the solid electrolyte substrate and the cathode electrode layer and/or the anode electrode layer.

Further, the electrically-conductive material layer is embedded with a part thereof exposed at the surface of the cathode electrode layer and/or the anode electrode layer.

Further, a cathode electrode material layer is formed on the cathode electrode layer side and an anode electrode material layer is formed on the anode electrode layer side of the interface of the conductor with the solid electrolyte substrate.

Further, the solid electrolyte substrate has a fixing material layer formed on the peripheral edge thereof.

Further, the electrically-conductive material layer is formed extending outside the solid electrolyte substrate, and the fixing material layer is formed with the protruding electrically-conductive material layer embedded therein on the periphery of the solid electrolyte substrate.

Further, there is provided a method for producing a solid oxide fuel cell including: a step of preparing an electrolyte sheet having a predetermined size from an electrolyte green sheet; a step of pressing an electrically-conductive material layer made of a plurality of conductors to one or both sides of the electrolyte sheet to bond the electrically-conductive material to the electrolyte sheet; a step of forming a cathode electrode paste layer on one side of the electrolyte sheet and an anode electrode layer on the other side of the electrolyte sheet; and a step of firing the electrolyte sheet, the cathode electrode paste layer and the anode electrode paste layer.

Further, there is provided a method for producing a solid oxide fuel cell including: a step of preparing an electrolyte sheet having a predetermined size from an electrolyte green sheet; a step of forming a cathode electrode paste layer on one side of the electrolyte sheet and an anode electrode layer on the other side of the electrolyte sheet; a step of pressing an electrically-conductive material layer made of a plurality of conductors to the cathode electrode paste layer and/or the anode electrode paste layer to bond the electrically-conductive material to the cathode electrode paste layer and/or the anode electrode paste layer; and a step of firing the electrolyte sheet, the cathode electrode paste layer and the anode electrode paste layer.

As mentioned above, the solid oxide fuel cell according to the invention includes a solid electrolyte substrate formed by a fired electrolyte powder and an electrically-conductive material layer of a plurality of conductors provided on one or both of the cathode electrode layer side and the anode electrode layer side thereof. In this arrangement, even when flame is directly applied to the solid oxide fuel cell, thermal shock due to sudden heating can difficultly occur, making it possible to enhance the thermal shock resistance of the solid oxide fuel cell more remarkably than in the case where a dense solid electrolyte substrate is used.

The provision of the electrically-conductive material layer makes it possible to make up for brittleness of fired electrolyte powder constituting the solid electrolyte substrate. Further, the electrically-conductive material layer can be utilized also as a current collecting electrode for solid oxide fuel cell. Moreover, when flame is directly supplied into the solid oxide fuel cell, this electrically-conductive material layer facilitates heat conduction to the entire surface of the fuel cell to rapidly rise up the fuel cell to its operating temperature and uniformalize and stabilize the operating temperature.

The solid oxide fuel cell according to the invention includes a fixing material layer formed on the peripheral edge of the solid electrolyte substrate formed by a fired electrolyte powder. This fixing material layer forms a frame by which the solid electrolyte substrate is surrounded, making it possible to enhance the mechanical strength of the solid oxide fuel cell.

Further, the method for the production of a solid oxide fuel cell according to the invention includes plane-pressing an electrically conductive material layer made of a plurality of conductors to one or both sides of an electrolyte sheet having a predetermined shape formed by an electrolyte green sheet, forming a cathode electrode paste layer on one side of the electrolyte sheet and an anode electrode paste layer on the other side of the electrolyte sheet, and then firing the electrolyte sheet, the cathode electrode paste layer and the anode electrode paste layer, whereby the solid electrolyte substrate, the cathode electrode layer and the anode electrode layer can be easily formed by a fired electrolyte powder and a step of sintering an electrolyte powder which has been heretofore practiced can be omitted, making it possible to simplify the production step and the process control and attain the reduction of cost of the solid oxide fuel cell.

### BRIEF DESCRIPTION OF THE DRAWINGS

FIGS. 1A and 1B are diagrams illustrating a first embodiment of the solid oxide fuel cell according to the invention.

FIGS. 2A and 2B are partly enlarged views illustrating a solid oxide fuel cell according to the invention.

FIG. 3 is a flow chart illustrating a specific example 1 of the procedure of production of the solid oxide fuel cell according to the invention.

FIG. 4 is a partly enlarged view illustrating an example of modification of the solid oxide fuel cell according to the first embodiment.

FIG. 5 is a flow chart illustrating a specific example 2 of the procedure of production of the solid oxide fuel cell according to the invention.

FIG. 6 is a diagram illustrating a second embodiment of the solid oxide fuel cell according to the invention.

FIG. 7 is a diagram illustrating an example of application of the solid oxide fuel cell according to the second embodiment.

FIG. 8 is a diagram illustrating a third embodiment of the solid oxide fuel cell according to the invention.

FIGS. 9A to 9C are diagrams illustrating an example of modification of the third embodiment of the solid oxide fuel cell according to the invention.

FIGS. 10A and l0B are diagrams illustrating the schematic configuration of an electricity generation device including a solid oxide fuel cell using a mixed fuel gas according to the related art technique.

FIG. 11 is a diagram illustrating a solid oxide fuel cell which allows direct utilization of flame to generate electricity.

### DETAILED DESCRIPTION OF THE PREFERRED EMBODIMENTS

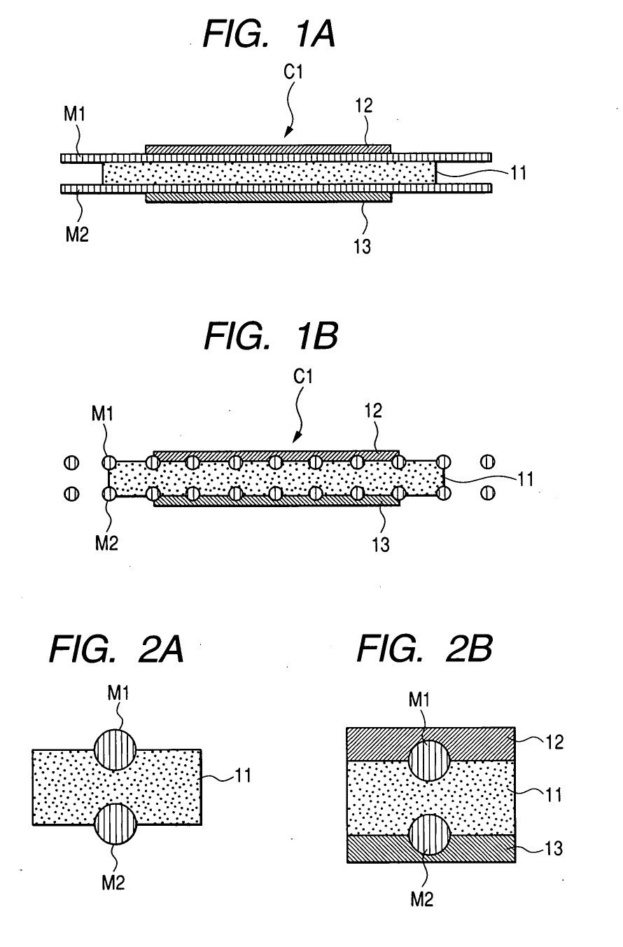

Embodiments of implementation of the solid oxide fuel cell of the invention will be described with reference to the configuration and production method of the solid oxide fuel cell in connection with FIGS. 1 to 9. The description of the configuration of the present embodiment of the solid oxide fuel cell will be preceded by the description of the electrolyte substrate material, the cathode electrode material and the anode electrode material which can be commonly used in solid oxide fuel cells.

As the solid electrolyte substrate for the solid oxide fuel cell according to the invention there may be used, e.g., any known material exemplified below.
a) YSZ (yttria-stabilized zirconia), ScSZ (scandia-stabilized zirconia), zirconia-based ceramics obtained by doping these materials with Ce, Al or the like
b) Ceria-based ceramics such as SDC (samaria-doped ceria) and GDC (gadolia-doped ceria)
c) LSGM (components: La, St, Ga, Mg) (lanthanum gallate), bismuth oxide-based ceramics

As the anode electrode layer to be formed on one side of the solid electrolyte substrate there may be used, e.g., any known material. Examples of such a material include the following materials.
d) Cermets of nickel with yttria-stabilized zirconia-based, scandia-stabilized-based or ceria-based (e.g., SDC, GDC, YDC) ceramics
e) Sintered material mainly including an electrically-conductive oxide (50% to 99% by weight) (As the electrically-conductive oxide there may be used nickel oxide having lithium dissolved in solid state therein or the like)
f) Metal made of platinum element or oxide thereof incorporated in the materials d) and e) in an amount of from 1% to 10% by weight
   Particularly preferred among these materials are materials d) and e).

Due to its excellent oxidation resistance, the sintered material mainly including the electrically-conductive oxide e) can prevent phenomena occurring due to the oxidation of the anode layer, e.g., drop of electricity generation efficiency or incapability of electricity generation due to the rise of the electrode resistivity of the anode layer and exfoliation of the anode layer from the solid electrolyte layer. As the electrically-conductive oxide there is preferably used nickel oxide having lithium dissolved therein in solid state. Further, the incorporation of a metal such as platinum group element or rhenium or oxide thereof in the materials d) and e) makes it possible to obtain a high electricity generation capability.

As the cathode electrode layer to be formed on the other side of the solid electrolyte substrate there may be used any known material. Examples of such a material include manganate (e.g., lanthanum strontium manganite), gallate and cobaltate (e.g., lanthanum strontium cobaltate, samarium strontium cobaltate) of an element belonging to the group III such as lanthanum having strontium (Sr) incorporated therein.

As previously mentioned, in the case of the solid oxide fuel cell according to the related art technique, a green sheet made of the aforementioned electrolyte material is sintered to form a ceramic material from which a dense solid electrolyte substrate is then prepared. Therefore, cracking can easily occur at the step of producing the fuel cell as well as due to thermal shock caused by heating during electricity generation.

On the other hand, it is confirmed that even the solid electrolyte substrate formed by a fired material obtained merely by firing a green sheet of an electrolyte powder (electrolyte powder is not sintered) rather than by completely sintering a green sheet of an electrolyte powder to form a ceramic material from which a dense solid electrolyte substrate is formed is capable of conducting oxygen ions (O²⁻) produced at the interface of the cathode electrode layer with the solid electrolyte substrate to the anode electrode layer.

The fired green sheet of en electrolyte powder is obtained by combusting the binder in the green sheet. In this arrangement, the fired green sheet has electrolyte particles fixed densely to each other or electrolyte particles packed therein. Therefore, the fired material is not so hard as ceramics but remains sufficiently shaped in solid electrolyte substrate. Further, the fired green sheet has aggregates formed by fixing electrolyte particles to each other and thus can difficultly undergo thermal shock due to external heating. Thus, the fired green sheet exhibits a higher thermal shock resistance than the dense solid electrolyte substrate.

Therefore, the thermal shock resistance of the fuel cell is enhanced by using the aforementioned fired green sheet of electrolyte powder as the solid electrolyte substrate for the solid oxide fuel cell of the invention. FIG. 1 depicts the configuration of a first embodiment of the solid oxide fuel cell according to the invention. FIG. 1A depicts a longitudinal section taken in one direction and FIG. 1B depicts a longitudinal section taken in the direction perpendicular to the one direction.

The solid oxide fuel cell C1 shown in FIGS. 1A and 1B includes a solid electrolyte substrate 11 formed by a fired green sheet of electrolyte powder, a cathode electrode layer 12 formed on one side of the substrate 11 and an anode electrode layer 13 formed on the other side of the substrate 11. The solid oxide fuel cell C1 has metallic meshes M1, M2 embedded therein as a reinforcement of the entire fuel cell and a current collector.

In FIGS. 1A and 1B, the metallic meshes M1, M2 are shown embedded in the interface of the solid electrolyte substrate 11 with the cathode electrode layer 12 and in the interface of the solid electrolyte substrate 11 with the anode electrode layer 13, respectively. The metallic meshes M1, M2 shown in these figures each are formed by a plurality of metal wires disposed parallel to each other and electrically connected to each other at the end thereof.

The aforementioned configuration of metallic mesh is merely exemplary. Not only a metallic mesh formed by a plurality of metal wires disposed parallel to each other but also a networked or lattice-like metallic mesh formed by a plurality of metal wires can be employed. The thickness of the metal wire to be used herein is preferably greater than the count of commonly used metallic mesh for current collection if the reinforcement of the entire fuel cell is intended. The metallic mesh is made of platinum wire, stainless steel wire or the like.

FIG. 2 is an enlarged view of a part of the solid C1 illustrating in a longitudinal section how a metallic mesh is embedded therein. FIG. 2A depicts how about half the metallic meshes M1, M2 are embedded in the green sheet of electrolyte powder and FIG. 2B depicts a cathode electrode paste layer and an anode electrode paste layer formed on the metallic mesh-embedded green sheet on the metallic mesh M1 side and the metallic mesh M2 side thereof, respectively. When the laminate is entirely fired, the green sheet is converted to a solid electrolyte substrate 11, the cathode electrode paste layer is converted to a cathode electrode layer 12 and the anode electrode paste layer is converted to an anode electrode layer 13. In this manner, the metallic meshes M1, M2 are embedded in the solid oxide fuel cell C1.

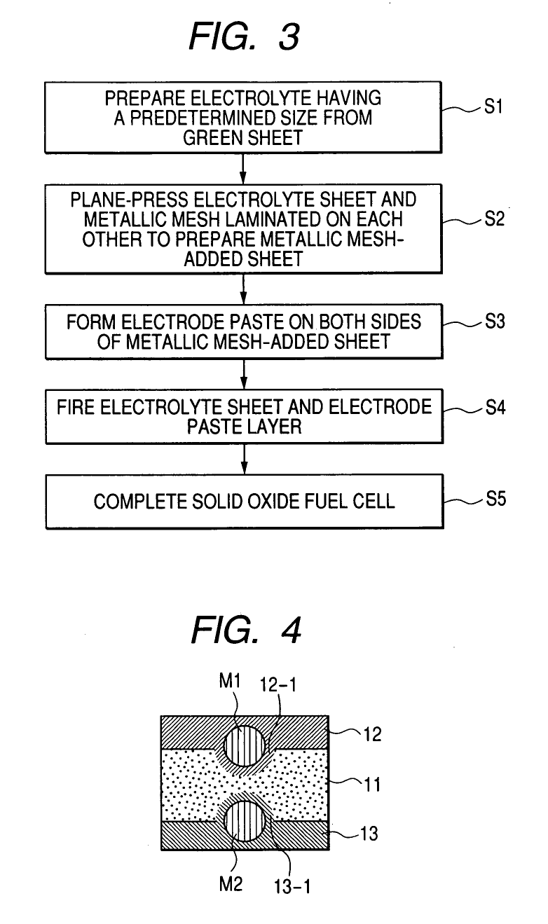

A specific example 1 of the process for the production of the solid oxide fuel cell having the aforementioned configuration will be described hereinafter in connection with a flow chart shown in FIG. 3. Firstly, a circular or rectangular electrolyte sheet having a predetermined size is prepared from a green sheet obtained by kneading a solid electrolyte material with a binder (Step S1). Subsequently, a metallic mesh is laminated and plane-pressed on the both sides of the electrolyte sheet to prepare a metallic mesh-added sheet (Step S2).

Subsequently, a cathode electrode paste is spread over one side of the metallic mesh-added sheet prepared at Step S2 by printing, and then dried. Thereafter, an anode electrode paste is spread over the other side of the metallic mesh-added sheet by printing, and then dried. Thus, a cathode electrode paste layer and an anode electrode paste layer are formed (Step S3). Thereafter, the electrolyte sheet, the cathode electrode paste layer and the anode electrode paste layer are fired (Step S4). In this manner, the solid oxide fuel cell C having the configuration shown in FIGS. 1 and 2 is completed (Step S5).

As mentioned above, in accordance with the aforementioned method for the production of a solid oxide fuel cell, the solid electrolyte substrate, the cathode electrode layer and the anode electrode layer are formed by a fired electrolyte powder and thus can be enhanced in its thermal shock resistance. Further, the step of sintering the electrolyte powder can be omitted to simplify the production process and the process control, making it possible to attain the reduction of cost of the solid oxide fuel cell.

While the production process shown in the flow chart of FIG. 3 involves Step S2 at which a metallic mesh is laminated on the both sides of the electrolyte sheet to form a metallic mesh-added sheet, one of the metallic meshes M1, M2 may be embedded in the electrolyte sheet to form the solid oxide fuel cell C. In this case, the electrolyte sheet and a sheet of metallic mesh are laminated and plane-pressed on each other at Step S2 to prepare the metallic mesh-added sheet. The metallic mesh-added sheet thus prepared has a metallic mesh present only on one side thereof. Therefore, a metallic mesh for current collection may be added to the other side of the electrolyte sheet after the formation of the electrode paste layer at Step S3.

FIG. 4 depicts a partly enlarge view of a modification of the solid oxide fuel cell according to the first embodiment. This partly enlarged view corresponds to the enlarge view shown in FIG. 2B. In the solid oxide fuel cell according to the first embodiment shown in FIG. 2B, about half the metal wire constituting the metallic meshes M1, M2 is embedded in the solid electrolyte substrate 11. When the metal wire is present embedded in the solid electrolyte substrate 11, the interface of the solid electrolyte substrate 11 cannot be supplied with oxygen ions from the cathode electrode layer 12 and fuel seeds from the anode electrode layer 13 in the portion of the metal wire.

When the embedding of the metallic mesh prevents oxygen ions or fuel seeds from being supplied into the solid electrolyte substrate 11, the area efficiency concerning the electricity generation by the fuel cell falls. An example of modification of the solid oxide fuel cell which provides an enhanced area efficiency even if the metallic mesh is embedded therein is shown in FIG. 4. In this modification example, a cathode electrode material layer 12-1 and an anode electrode material layer 13-1 are formed surrounding the metal wire between the metallic meshes M1, M2 and the solid electrolyte substrate 11. The interposition of the cathode electrode material layer 12-1 and the anode electrode material layer 13-1 allows the supply of oxygen ions or fuel seeds into the solid electrolyte substrate 11 also in the portion of the metal wire.

While the configuration shown in FIG. 2B is prepared by the production process shown in the flow chart of FIG. 3, the production of the solid oxide fuel cell according to the present modification example involves printing of an electrode paste with the interposition of which a metallic mesh is plane-pressed onto the electrolyte sheet to prepare a metallic mesh-added sheet at Step S2 in the production process shown in the flow chart of FIG. 3. Subsequently, at Step S3, an electrode paste is printed in such a manner that a cathode electrode layer and an anode electrode layer can be formed to a required thickness. Thus, electrode paste layers are formed. In accordance with this production process, the configuration of the modification example shown in FIG. 4 can be realized.

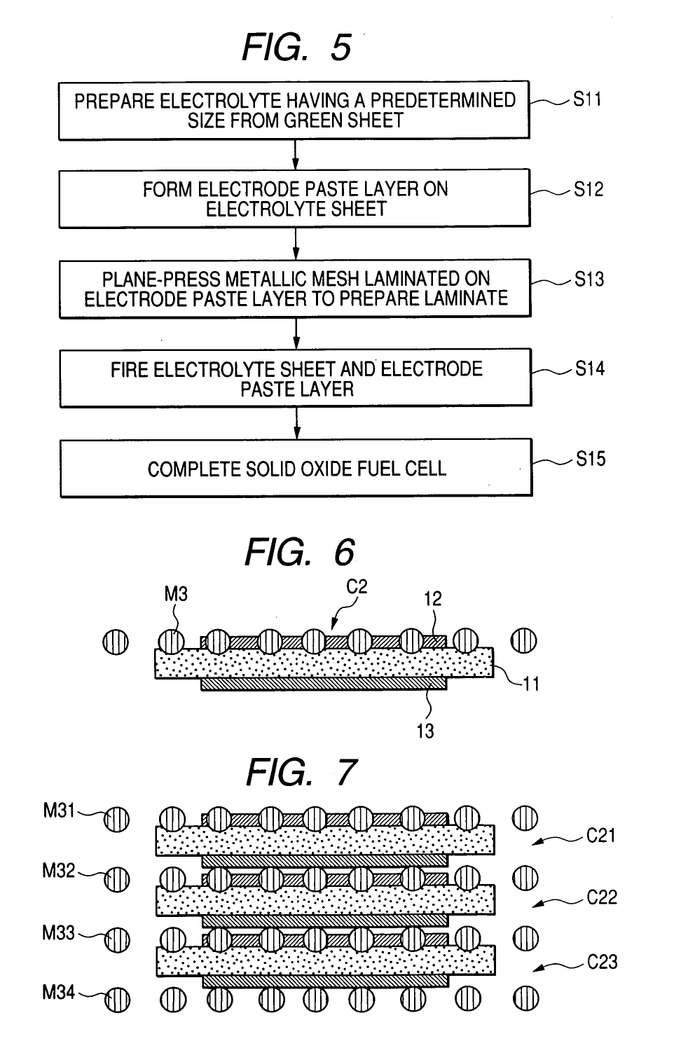

In the production process according to the flow chart of FIG. 3 described above, a solid oxide fuel cell according to the first embodiment having metallic meshes completely embedded in the electrode layers and the solid electrolyte substrate is produced as shown in FIGS. 1 and 2. On the other hand, a specific example 2 of the process for the production of a solid oxide fuel cell having metallic meshes partly exposed at the surface of the electrode layers is shown in the flow chart of FIG. 5.

In accordance with the procedure of the production process according to the flow chart of FIG. 5, a circular or rectangular electrolyte sheet is prepared from a green sheet obtained by kneading a solid electrolyte material with a binder Step S11). Subsequently, a cathode electrode paste is spread over one side of the electrolyte substrate by printing while an anode electrode paste is spread over the other side of the electrolyte substrate by printing to form a cathode electrode paste layer and an anode electrode paste layer (Step S12).

Subsequently, a metallic mesh is laminated and plane-pressed onto the cathode electrode paste layer and the anode electrode paste layer thus formed to a metallic mesh-added laminate (Step S13). During this procedure, the diameter of the metal wire constituting the metallic mesh to be added has been predetermined to be greater than the thickness of the cathode electrode paste layer and the anode electrode paste layer thus formed. In this arrangement, when the metallic mesh is plane-pressed onto the cathode electrode paste layer and the anode electrode paste layer, the metal wire can be partly exposed at the top of the cathode electrode paste layer and the anode electrode paste layer. Further, when the diameter of the metal wire is predetermined to be greater than the thickness of the electrode paste layers, the fuel cell can be reinforced itself.

The metallic mesh-added laminate thus formed is then fired (Step S14). Thus, a solid oxide fuel cell C having a metal wire partly exposed at the top of the cathode electrode paste layer and the anode electrode paste layer is completed (Step S15). Even in the case where the fuel cell is produced by this production process, an electrode material layer may be provided interposed between the metal wire and the solid electrolyte substrate as shown in FIG. 4.

As mentioned above, in accordance with the aforementioned method for the production of a solid oxide fuel cell according to the specific example 2, the solid electrolyte substrate, the cathode electrode layer and the anode electrode layer are formed by a fired electrolyte powder and thus can be enhanced in its thermal shock resistance. Further, the step of sintering the electrolyte powder can be omitted to simplify the production process and the process control, making it possible to attain the reduction of cost of the solid oxide fuel cell. Moreover, since the metal wire is partly exposed to the top of the electrode layers, the electrical connection of a plurality of solid oxide fuel cells laminated on each other can be simplified.

A solid oxide fuel cell according to the second embodiment prepared by the production process according to the specific example 2 described above is shown in FIG. 6. In accordance with the production process according to the specific example 2 shown in the flow chart of FIG. 5, the metallic meshes are disposed on the respective side of the solid electrolyte substrate with the solid electrolyte substrate interposed therebetween. On the other hand, FIG. 6 depicts a solid oxide fuel cell C including a metallic mesh provided on only one side of the solid electrolyte substrate.

FIG. 6 depicts a longitudinal section of the solid oxide fuel cell C2 as in FIG. 1B. The solid oxide fuel cell C2 shown in FIG. 6 includes a solid electrolyte substrate 11 made of fired electrolyte powder, a cathode electrode layer 12 formed on one side of the substrate 11 and an anode electrode layer 13 formed on the other side of the substrate 11 as basic fuel cell components. A metallic mesh M3 including a plurality of metal wires is embedded in the cathode electrode layer 12 with the metal wires being partly exposed at the surface of the cathode electrode layer 12.

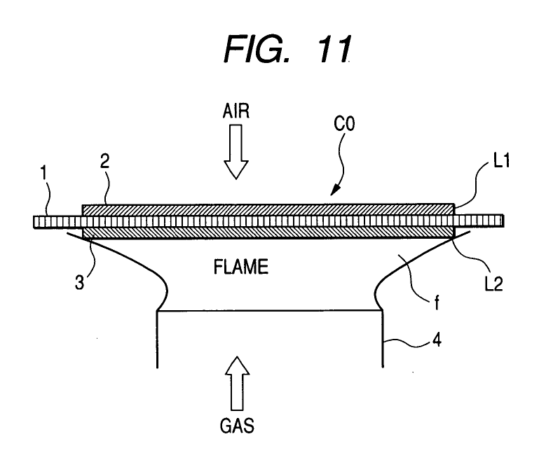

The solid oxide fuel cell C2 shown in FIG. 6, too, can act as an electricity generation device allowing direct utilization of flame as in the case shown in FIG. 11. When the entire surface of the anode electrode layer 13 of the solid oxide fuel cell C2 is exposed directly to flame f, electricity can be generated. Since the solid oxide fuel cell C2 has the metallic mesh M3 provided only on the cathode electrode layer 12 side thereof and no metallic mesh present on the anode electrode layer 13 side thereof, it is necessary that a lead wire L2 having a current collecting electrode be provided on the anode electrode layer 13 as in the case of the solid oxide fuel cell C of FIG. 11.

On the other hand, FIG. 7 depicts the case where a plurality of sheets of solid oxide fuel cell C2 shown in FIG. 6 are laminated rather than being singly used to produce an electricity generation device. In FIG. 7, three sheets of solid oxide fuel cell C21 to C23 having the same configuration as that of the solid oxide fuel cell C2 of FIG. 6 are shown laminated. In the sequential configuration, the metallic mesh in the lower solid oxide fuel cell comes in contact with the anode electrode layer in the upper solid oxide fuel cell in such an arrangement that the exposed portion of the metallic mesh M32 in the solid oxide fuel cell C22 comes in contact with the anode electrode layer in the solid oxide fuel cell C21.

Thus, when the solid oxide fuel cells C21 to C23 are merely laminated, the anode electrode layer in the solid oxide fuel cell C23, which is disposed lowermost, has no metallic mesh provided therein. A metallic mesh M34 for the purpose of drawing output is then provided in contact with the anode electrode layer. In this arrangement, the various solid oxide fuel cells C21 to C23 are electrically connected in series to each other, making it possible to develop a raised voltage output between the metallic mesh M31 and the metallic mesh M34.

Further, the metal wire constituting the metallic mesh is partly exposed at the surface of the cathode electrode layer and extends from the surface of the cathode electrode layer. Thus, when these solid oxide fuel cells are laminated, a gap is formed between the cathode electrode layer of a lower solid oxide fuel cell and the anode electrode layer of the upper adjacent solid oxide fuel cell. The gap thus formed can be used as a channel for mixed fuel.

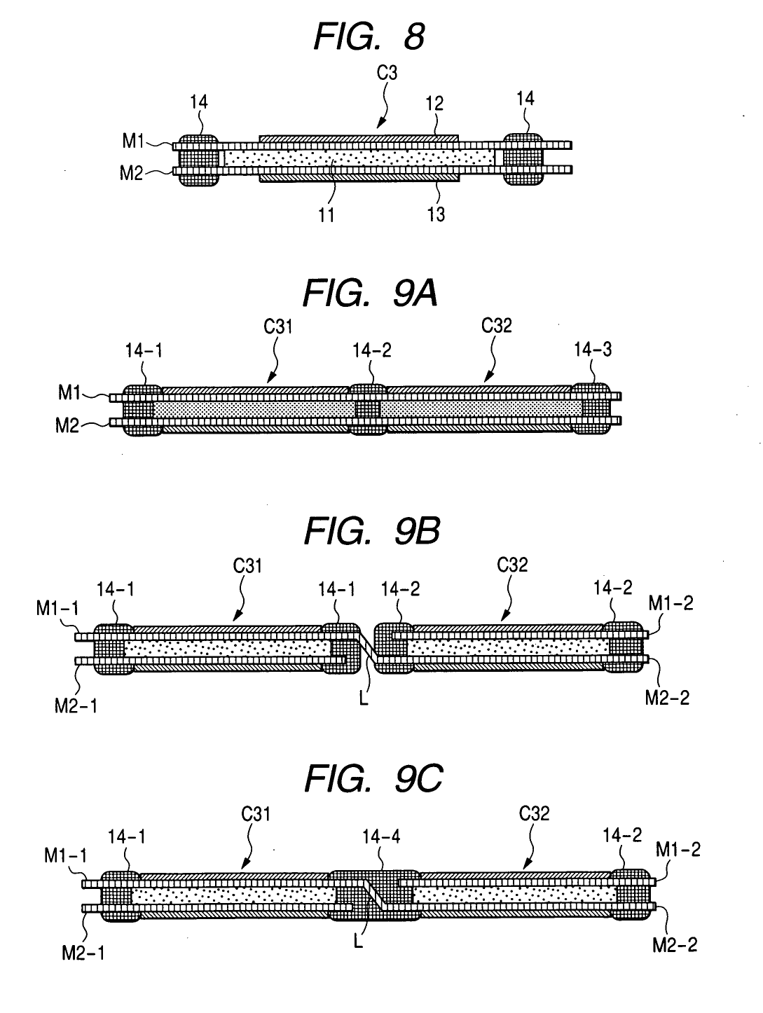

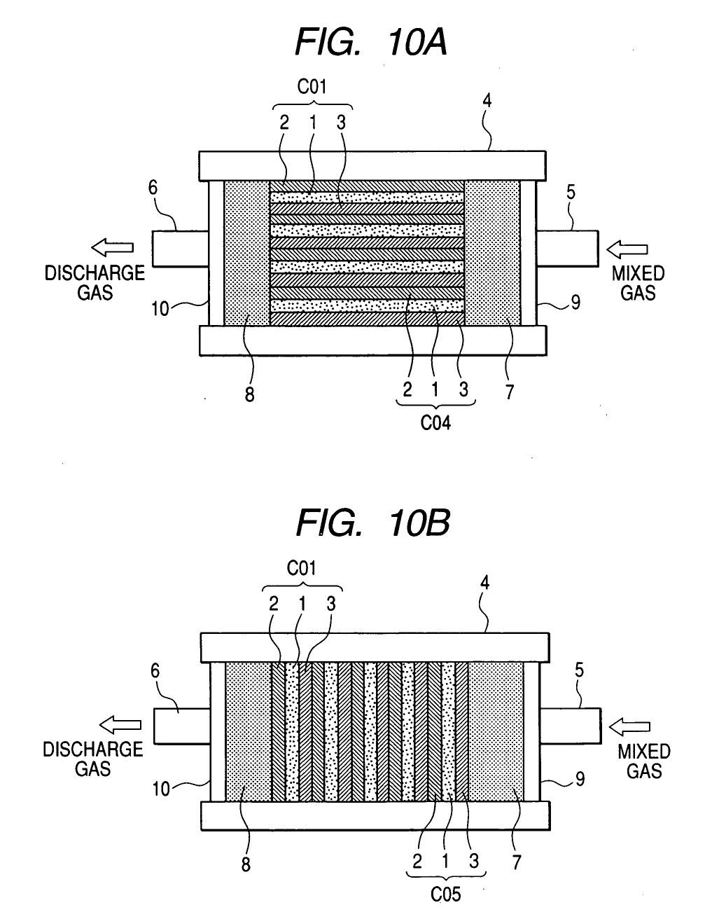

A solid oxide fuel cell C3 according to a third embodiment obtained by further reinforcing the solid oxide fuel cell C1 according to the first embodiment shown in FIG. 1 is shown in FIG. 8. The solid oxide fuel cell C1 according to the first embodiment can be applied to an electricity generation device which is operated by the direct use of flame. However, when the solid oxide fuel cell C1 according to the first embodiment is used as it is, the fuel cell can lack strength. In order to solve this problem, an insulating fixing material layer 14 is provided on the external extension of the metallic meshes M1, M2 embedded in the solid oxide fuel cell C3 as shown in FIG. 8 with an inorganic adhesive.

The fixing material layer 14 is provided surrounding the solid oxide fuel cell C3 with the extension of the metallic meshes M1, M2 embedded therein and forms a frame body for the solidoxide fuel cell C3. The formation of the frame body makes it possible to inhibit the deflection of the solid oxide fuel cell C3 and enhance the strength thereof. As a result, the cracking of the solid electrolyte substrate can be prevented. While the fixing material layer 14 shown in FIG. 8 is disposed apart from the peripheral edge of the solid electrolyte substrate 11, the fixing material layer may be formed surrounding the peripheral edge of the solid electrolyte substrate.

FIG. 9 depicts an example of modification of the solid oxide fuel cell according to the third embodiment. The solid oxide fuel cell C3 shown in FIG. 8 is singly used. On the other hand, the modification example shown in FIG. 9 has the same configuration as that of the solid oxide fuel cell C3 shown in FIG. 8 except that the fixing material layer is formed surrounding the peripheral edge of the solid electrolyte substrate and a plurality of solid oxide fuel cells C3 are electrically connected parallel or in series to each other to form an electricity generation device.

FIG. 9A depicts a plurality of solid oxide fuel cells connected parallel to each other wherein the parallel combination of two sheets of solid oxide fuel cell C31 and C32 is typically shown by way of example. The continuous provision of metallic meshes M1, M2 embedded in the solid oxide fuel cells C31, C32, respectively, common to both the fuel cells makes it possible to realize an electrical parallel connection. Fixing material layers 14-1, 14-2 and 14-3 are provided on the periphery of the solid oxide fuel cells C31, C32, respectively.

The production of the aforementioned solid oxide fuel cell can be carried out by the procedure of the production process according to the flow chart of FIG. 3. At Step S2, a plurality of electrolyte substrates are disposed juxtaposed between the metallic meshes, and then plane-pressed onto the metallic meshes to form a metallic mesh-added sheet. Subsequently, at Step S3, a cathode electrode paste layer and an anode electrode paste layer are formed every electrolyte substrate. At Step S4, the laminate is fired. Thereafter, a fixing material layer is provided on the peripheral edge of the solid electrolyte substrates to obtain a parallel combination of a plurality of solid oxide fuel cells as shown in FIG. 9A.

FIGS. 9B and 9C each depict the case where a plurality of solid oxide fuel cells disposed in plane are electrically connected in series to each other wherein the parallel combination of two sheets of solid oxide fuel cell C31 and C32 is typically shown by way of example as in the case of FIG. 9A. In the case of FIGS. 9B and 9C, too, solid oxide fuel cells according to the third embodiment are used and metallic meshes M1, M2 are embedded in each of these solid oxide fuel cells extending outward beyond the solid electrolyte substrate.

In the case of FIG. 9B, the solid oxide fuel cells C31, C32 are each prepared by the procedure of the production process according to the flow chart of FIG. 3 and fixing material layers 14-1, 14-2 are provided on the peripheral edge of the solid electrolyte substrates, respectively. Thereafter, the metallic mesh M1-1 in the solid oxide fuel cell C31 and the metallic mesh M2-2 in the solid oxide fuel cell C32 are connected to each other with a metal connecting wire L. In this arrangement, the solid oxide fuel cells C31, C32 are electrically connected in series to each other. The electric power output thus developed is drawn through the metallic meshes M2-1 and M1-2. The electrical connection of these solid oxide fuel cells can be made with an extending metal mesh instead of the metal connecting wire L.

In the case of FIG. 9C, the solid oxide fuel cells C31, C32 are each prepared by the procedure of the production process according to the flow chart of FIG. 3. Thereafter, the metallic mesh M1-1 in the solid oxide fuel cell C31 and the metallic mesh M2-2 in the solid oxide fuel cell C32 are connected to each other with a metal connecting wire L. Fixing material layers 14-1, 14-2 and 14-4 are provided on the peripheral edge of the solid electrolyte substrates, respectively. In this case, too, an extending metallic mesh can be used instead of the metal connecting wire L.

In this arrangement, the solid oxide fuel cells C31, C32 are electrically connected in series to each other. The electric power output thus developed is drawn through the metallic meshes M2-1 and M1-2. In the case of FIG. 9B, a plurality of solid oxide fuel cells are merely connected structurally to each other with the metal connecting wire L to provide the entire fuel cell with a reduced rigidity. In the case of FIG. 9C, however, a plurality of solid oxide fuel cells are laminated into a flat sheet that renders the entire fuel cell less deflectable as in the case of FIG. 9A.

As mentioned above, the solid electrolyte substrate of the solid oxide fuel cell according to the invention is formed by a fired electrolyte powder, making it possible to obtain a solid oxide fuel cell which can relax the generation of thermal shock due to direct exposure of flame and thus exhibits an enhanced thermal shock resistance. Further, the employment of a fired electrolyte powder unnecessitates the sintering step of forming a dense structure and thus simplifies the production process, making it possible to attain cost reduction. An example of the solid oxide fuel cell according to the invention will be described hereinafter.

### EXAMPLE

A mixture of a samaria-doped ceria (Ce_{0.8}Sm_{0.2}O_{1.9}, SDC), a polyvinyl butyral and dibutyl phthalate is slurried by a ball mill method. A green sheet having a thickness of about 0.2 mm is then prepared from the slurry. The green sheet thus prepared is then stamped to a sheet having a diameter of about 20 mm. A stainless steel is then welded to two sheets of stamped stainless steel (SUS304) mesh (#400) having a diameter of about 20 mm. The two sheets of mesh are then plane-pressed with the green sheet interposed therebetween to form an integrated body.

Subsequently, a 50 wt-% mixture paste of samarium strontium cobaltite (SSC) and SDC is spread over one side of the green sheet integrated to mesh, and then dried. A 15:45:40 (by weight) mixture paste of NiO—CoO—SDC is spread over the other side of the green sheet, and then dried. The laminate thus obtained is then fired at 600° C. in the atmosphere for 2 hours.

The solid oxide fuel cell thus obtained includes a solid oxide fuel cell, a cathode electrode layer and an anode electrode layer formed by a fired electrolyte powder. The solid oxide fuel cell thus obtained had a lower mechanical strength than the solid oxide fuel cell having a dense structure but exhibited so very high a thermal shock resistance that it cannot be damaged even when directly exposed to flame and rapidly heated. The solid oxide fuel cell thus obtained is confirmed to have an open circuit voltage of about 0.5 V and a short-circuit current of 130 mA.

What is claimed is:

1. A solid oxide fuel cell comprising:
a solid electrolyte substrate formed by a fired electrolyte powder;
a cathode electrode layer formed on one side of the solid electrolyte substrate; and
an anode electrode layer formed on the other side of the solid electrolyte substrate, wherein
an electrically-conductive material layer made of a plurality of conductors is provided on one or both of the cathode electrode layer side and the anode electrode layer side.

2. The solid oxide fuel cell as defined in claim 1, wherein
the plurality of conductors form a metallic mesh.

3. The solid oxide fuel cell as defined in claim 1, wherein
the electrically-conductive material layer is embedded in the cathode electrode layer and/or in the anode electrode layer.

4. The solid oxide fuel cell as defined in claim 1, wherein
the electrically-conductive material layer is embedded in over the solid electrolyte substrate and the cathode electrode layer and/or the anode electrode layer.

5. The solid oxide fuel cell as defined in claim 4, wherein
the electrically-conductive material layer is embedded with a part thereof exposed at the surface of the cathode electrode layer and/or the anode electrode layer.

6. The solid oxide fuel cell as defined in claim 4, wherein
a cathode electrode material layer is formed on the cathode electrode layer side and an anode electrode material layer is formed on the anode electrode layer side of the interface of the conductor with the solid electrolyte substrate.

7. The solid oxide fuel cell as defined in claim 1, wherein
the solid electrolyte substrate has a fixing material layer formed on the peripheral edge thereof.

8. The solid oxide fuel cell as defined in claim 1, wherein
the electrically-conductive material layer is formed extending outside the solid electrolyte substrate, and
the fixing material layer is formed with the protruding electrically-conductive material layer embedded therein on the periphery of the solid electrolyte substrate.

9. A method for producing a solid oxide fuel cell comprising:
a step of preparing an electrolyte sheet having a predetermined size from an electrolyte green sheet;
a step of pressing an electrically-conductive material layer made of a plurality of conductors to one or both sides of the electrolyte sheet to bond the electrically-conductive material to the electrolyte sheet;
a step of forming a cathode electrode paste layer on one side of the electrolyte sheet and an anode electrode paste layer on the other side of the electrolyte sheet; and
a step of firing the electrolyte sheet, the cathode electrode paste layer and the anode electrode paste layer.

10. A method for producing a solid oxide fuel cell comprising:
a step of preparing an electrolyte sheet having a predetermined size from an electrolyte green sheet;
a step of forming a cathode electrode paste layer on one side of the electrolyte sheet and an anode electrode paste layer on the other side of the electrolyte sheet;
a step of pressing an electrically-conductive material layer made of a plurality of conductors to the cathode electrode paste layer and/or the anode electrode paste layer to bond the electrically-conductive material to the cathode electrode paste layer and/or the anode electrode paste layer; and
a step of firing the electrolyte sheet, the cathode electrode paste layer and the anode electrode paste layer.
